(19) United States
(12) Patent Application Publication
(10) Pub. No.: US 2016/0068665 A1
(43) Pub. Date: Mar. 10, 2016

(54) CELLULOSE ESTER PLASTICS AND METHODS AND ARTICLES RELATING THERETO

(71) Applicant: Celanese Acetate LLC, Irving, TX (US)

(72) Inventors: Naresh Budhavaram, Florence, KY (US); Abhishek Ambekar, Florence, KY (US); Michael Combs, Pembroke, VA (US); Christopher McGrady, Florence, KY (US); Adam Larkin, Dallas, TX (US); Bing Lu, Union, KY (US); Nagarjuna Palyam, Cincinnati, OH (US); Marilyn T. Collins, Florence, KY (US); Lizbeth Milward Niebla, Kennesaw, GA (US); Wendy C. Bisset, Eggleston, VA (US); Syed Mazahir, Cincinnati, OH (US)

(73) Assignee: Celanese Acetate LLC, Irving, TX (US)

(21) Appl. No.: 14/848,605

(22) Filed: Sep. 9, 2015

Related U.S. Application Data
(60) Provisional application No. 62/047,888, filed on Sep. 9, 2014.
(60) Provisional application No. 62/047,930, filed on Sep. 9, 2014.
(60) Provisional application No. 62/048,001, filed on Sep. 9, 2014.

(51) Int. Cl. C08L 1/12; B29C 45/00; C08L 23/12; C08K 5/11; C08K 5/1565

(52) U.S. Cl. CPC C08L 1/12; C08K 5/11; C08K 5/1565; C08L 23/12; B29C 45/0001; B29K 2001/12

(57) ABSTRACT

Cellulose ester plastics may be formulated to have a depressed melt processing temperatures, improved heat resistance, increased mechanical stability, or some combination thereof. For example, in some instances, a cellulose ester plastic may include a plasticized cellulose ester at about 1% to about 99% by weight of the cellulose ester plastic, the plasticized cellulose ester consisting of a cellulose ester at about 60% to about 90% by weight of the plasticized cellulose ester and a plasticizer at about 10% to about 40% by weight of the plasticized cellulose ester, wherein the plasticizer comprises a carbonate ester, a polyol benzoate, or both; and a thermoplastic polymer at about 1% to about 99% by weight of the cellulose ester plastic; and wherein the cellulose ester plastic is melt processable.

### BACKGROUND

The exemplary embodiments described herein relate to cellulose ester plastic compositions, and methods and articles relating thereto.

Cellulose esters are generally considered environmentally-friendly polymers because they are recyclable, degradable, and derived from renewable sources like wood pulp. Despite this, cellulose esters have not been widely used in plastic compositions due to processing difficulties.

In many instances, cellulose esters are not melt processable because the melting temperature of the cellulose ester is too close to the degradation temperature of the cellulose ester. Generally, plasticizers are used to reduce the melt temperature and increase the melt flow index (MFI) of the cellulose ester, which may render the cellulose ester melt processable (e.g., compatible with injection molding techniques). However, the plasticizer also decreases the deflection temperature under load (DTUL) (also referred to as heat deflection temperature) of the cellulose ester composition.

As used herein, the term “DTUL” refers to the temperature at which a plastic sample deforms under specific load. The DTUL of a plastic composition provides an indication of how the plastic composition can be used in articles (i.e., the temperature and load that the plastic composition or article produced therewith can withstand for prolonged periods of time). For example, medical articles that are sterilized by autoclave and automotive interior parts should be produced with a plastic composition having a higher DTUL than a plastic composition used to make plastic bags and storage boxes.

### BRIEF DESCRIPTION OF THE DRAWINGS

The following figures are included to illustrate certain aspects of the embodiments presented herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is an exemplary piston stroke-temperature plot used to determine the flow initiation temperature.

FIG. 2 illustrates a bottle with a cap where each may independently be formed by a cellulose ester plastic described herein.

FIG. 3 illustrates a food container with a lid where each may independently be formed by a cellulose ester plastic described herein.

FIG. 4 illustrates a protective cover and screen cover for a mobile phone, which may independently be formed by a cellulose ester plastic described herein.

FIG. 5 is a plot of DTUL at 1.8 MPa versus the percent plasticizer for several cellulose ester plastics.

FIG. 6 is a plot of melt flow index versus the percent polypropylene for several cellulose ester plastics.

FIG. 7 is a plot of Charpy notched impact strength versus the percent polypropylene for several cellulose ester plastics.

FIG. 8 is a plot of DTUL versus the percent polypropylene for several cellulose ester plastics.

FIG. 9 provides data relating to the tensile strength and flexural modulus of cellulose ester plastic samples according to at least some embodiments described herein.

FIG. 10 provides data relating to the tensile strength at break, the tensile strength at yield, and the flexural strength at 3.5% strain of cellulose ester plastic samples according to at least some embodiments described herein.

FIG. 11 provides data relating to the elongation to break and the elongation to yield of cellulose ester plastic samples according to at least some embodiments described herein.

FIG. 12 provides data relating to the Charpy impact strength notched of cellulose ester plastic samples according to at least some embodiments described herein.

FIG. 13 provides data relating to the MFI of cellulose ester plastic samples according to at least some embodiments described herein.

FIG. 14 provides data relating to the melt viscosity of cellulose ester plastic samples according to at least some embodiments described herein.

### DETAILED DESCRIPTION

The exemplary embodiments described herein include compositions, methods, and articles that relate to cellulose ester plastic compositions (also referred to herein as “cellulose ester plastics”). The cellulose ester plastics described herein may have depressed melt processing temperatures, improved heat resistance (as determined by DTUL), increased mechanical stability (as determined by tensile strength, flexural modulus, and notched Charpy impact), or some combination thereof.

Depressing the melt processing temperature may advantageously allow for forming articles at lower temperature to mitigate degradation of the cellulose ester. Additionally, the final article may have improved heat resistance and/or increased mechanical stability that allows for the application of cellulose esters in plastic articles not previously realized. Further, the cellulose ester plastics described herein and articles produced therefrom would have the added environmental benefits associated with cellulose esters (e.g., recyclability, degradability, and renewable raw materials).

As used herein, the term “bio-derived” refers to a compound or portion thereof originating from a biological source or produced via a biological reaction. The bio-derived portion of cellulose ester plastics described herein refers to the mass percent that is bio-derived.

As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

As used herein, the term “non-volatile” refers to compounds having a boiling point of greater than about 400° C.

As used herein, the term “semi-volatile” refers to compounds having a boiling point of greater than about 260° C. to about 400° C.

As used herein, the term “volatile” refers to compounds having a boiling point of about 50° C. to about 260° C.

As used herein, the term “molecular weight” refers to a polystyrene equivalent number average molecular weight (“Mₑ”) as determined by gel permeation chromatography.

As used herein, the term “water-free” refers to a composition having no more water than is naturally present at standard temperature and pressure with about 100% relative humidity. As used herein, the term “substantially water-free” refers to a composition having no more than about 1% by weight of water above the concentration of water that is naturally present at standard temperature and pressure with 100% relative humidity.

As used herein, the terms “melt processable” and derivations thereof refer to compositions that form homogeneous pellets when processed according to the following procedure: (1) compounding the components of the composition at the throughput rate of 40 lb/hr with screw speed of 250 rpm at melt temperature 210° C. in a 25 mm twin screw extruder (e.g., a Krupp-Werner&Pfleiderer ZSK-25 extruder) to form a melt, (2) extruding the melt through a die head with 2 mm die hole at 210° C. into a 25° C. water bath to form a plastic string where during extrusion the melt is maintained at 210° C., and (3) chopping the plastic string with a pelletizer (e.g., a Cumberland pelletizer) into pellets or lengths of 5 mm. The resultant pellets are considered “homogeneous” when at least 80% of the pellets formed vary in weight by 10% or less. It should be noted that the term “melt processable plastic” or variations thereof does not imply that the plastic was prepared by the foregoing method, but rather that a “melt processable plastic” when processed by the foregoing method produces homogenous pellets.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

### I. Compositions

The cellulose ester plastic described herein include a base polymer composition that comprises plasticized cellulose esters optionally blended with other thermoplastic polymers. As used herein, the term “plasticized cellulose ester” refers to a composition consisting of one or more cellulose esters and one or more plasticizers. The cellulose ester plastics described herein may optionally further include a compatibilizer, a tackifying resin, fillers, and/or other additives (e.g., antioxidants, crosslinkers, dyes, waxes, and the like, and combinations thereof).

In some embodiments, the base polymer composition may be included in a cellulose ester plastic described herein in an amount of about 20% to about 100% by weight of the cellulose ester plastic.

In some embodiments, the base polymer composition of a cellulose ester plastic described herein may include plasticized cellulose esters at about 1% to about 99% by weight of the base polymer composition and a thermoplastic polymer at about 99% to about 1% by weight of the base polymer composition. Subsets of the foregoing ranges that may also be applicable include about 1% to about 10%, about 1% to about 20%, about 20% to about 75%, about 50% to about 99%, about 50% to about 90%, or about 75% to about 99% by weight of the base polymer composition.

In some instances, the thermoplastic polymers may reduce the melt processing temperature of the cellulose ester plastics, which may allow for reducing the concentration of plasticizer in the plasticized cellulose ester. The reduced plasticizer may increase the DTUL of the cellulose ester plastics. This may allow for injection molding the cellulose ester plastics into articles that experience higher temperatures and higher loads when used. Such articles would also have the added environmental benefits associated with cellulose esters (e.g., recyclability, degradability, and renewable raw materials). Exemplary articles may include vehicle interior parts (e.g., door handles, cup holders, dashboards, and glove boxes), appliance components, food and beverage containers, food and beverage container lids, electrical and electronic device enclosures (e.g., computer monitor enclosures, laptop enclosures, cellular phone enclosures), and the like.

Examples of thermoplastic polymers that may be blended with the plasticized cellulose esters to form the base polymer composition may include, but are not limited to, polyolefins (e.g., polyethylene and polypropylene), polyalphaolefins, polyesters, ethylene vinyl acetate copolymers, polyvinyl acetate, polyvinyl alcohol (“PVOH”), a polyethyleneimine, polyacrylates, polymethacrylates, polyacrylamides, polyacrylonitriles, polyimides, polyamides, polyvinyl chloride, polysiloxanes, polyurethanes, polystyrene, polyetheramide copolymers, styrene-butadiene copolymers, styrene-butadiene-styrene copolymers, styrene-isoprene-styrene copolymers, styrene-ethylene-butylene-styrene copolymers, styrene-ethylene-propylene-styrene copolymers, butyl rubber, polyisobutylene, isobutylene-isoprene copolymers, acrylics, nitriles, and combinations thereof. For example, polyolefins may be blended with plasticized cellulose esters to produce cellulose ester plastics suitable for making vehicle interior parts and food and beverage containers and lids.

In some instances, the thermoplastic polymers blended with the plasticized cellulose esters to form the base polymer composition may be sufficiently hydrophobic that a compatibilizer is needed to produce a homogeneous blend. Exemplary compatibilizers may be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. Additional exemplary compatibilizers may be polyethylene glycol (PEG) less than about 10,000 molecular weight (e.g., PEG-300). Combinations of the foregoing may also be used. In some embodiments, compatibilizers may be present in a cellulose ester plastic in an amount of about 0.1% to about 20% by weight of the cellulose ester plastic.

Generally, the plasticized cellulose esters described herein include at least one cellulose ester and at least one plasticizer. In some embodiments, plasticizers may be about 10% to about 40% by weight of the plasticized cellulose ester, and the cellulose esters may be about 60% to about 90% by weight of the plasticized cellulose ester. Subsets of the foregoing ranges may also be applicable include the plasticizer at about 10% to about 20%, about 10% to about 30%, about 20% to about 30%, about 20% to about 40%, or about 30% to about 40% by weight of the plasticized cellulose ester and/or the cellulose ester at about 60% to about 70%, about 60% to about 80%, about 70% to about 80%, about 70% to about 90%, or about 80% to about 90% by weight of the plasticized cellulose ester.

Plasticizers suitable for use in conjunction with a plasticized cellulose ester described herein may, in some embodiments, include, but are not limited to,

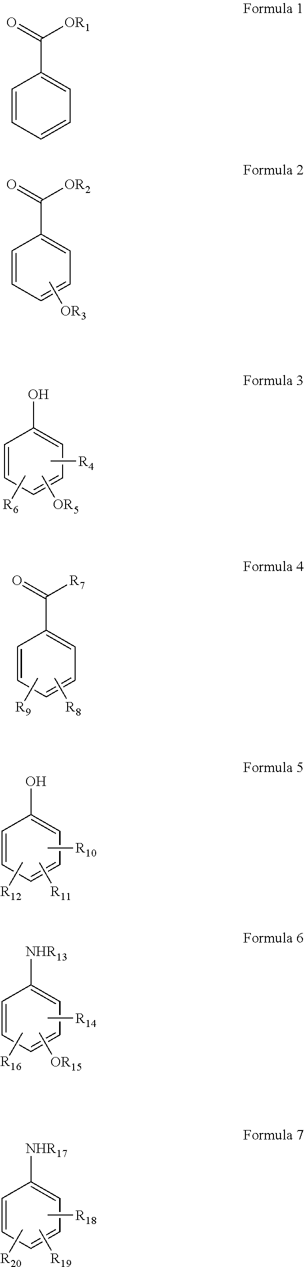

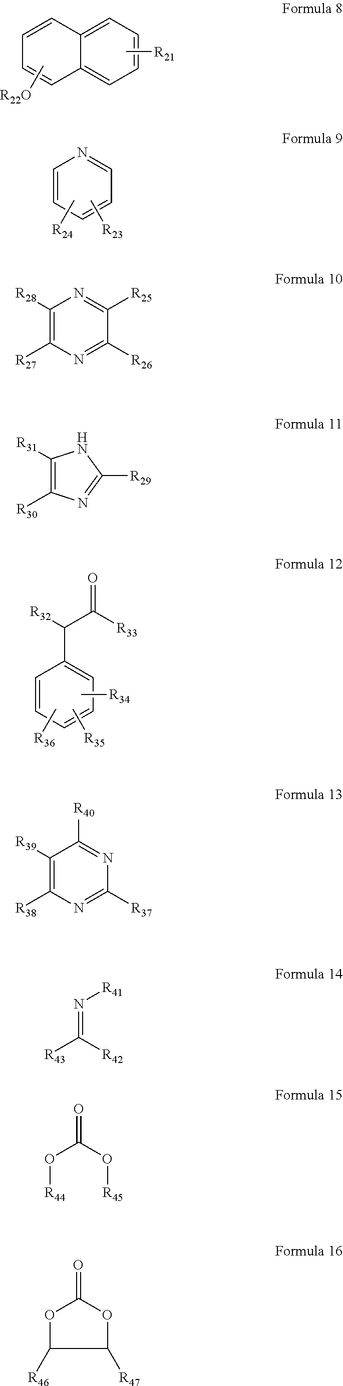

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 15 wherein R44 and R45 are each independently C₁-C₁₆ alkyl or aryl; Formula 16 wherein R46 and R47 are each independently hydrogen or C₁-C₁₂ alkyl; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R48HN-R49-NHR50 where R48 and R50 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R49 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with a plasticized cellulose ester described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol tribenzoate, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Polyol benzoate and carbonate ester plasticizers, individually or together, appear to uniquely effect the mechanical properties of cellulose esters as compared to traditional plasticizers like triacetin and diacetin. More specifically, carbonate ester plasticizers appear to be more efficient plasticizers. Accordingly, less plasticizer may be used, which increases the DTUL of the cellulose ester plastic. Additionally, carbonate ester plasticizers may be used at concentrations lower than traditional plasticizers to achieve melt processable plasticized cellulose esters. By way of nonlimiting example, cellulose acetate plasticized with about 15% propylene carbonate is melt processable, whereas cellulose acetate plasticized with less than 20% triacetin is not melt processable (under the same conditions). Further, polyol benzoate plasticizers enhance DTUL by increasing the DTUL for the same concentration of plasticizer. By way of nonlimiting example, cellulose acetate plasticized with about 28% glyceryl tribenzoate has a DTUL about 15% greater than cellulose acetate plasticized with 28% triacetin.

Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

If polyol benzoates and/or carbonate ester plasticizers are used in conjunction with other plasticizers, a cellulose ester plastic described herein may be formulated with a ratio of the carbonate ester plasticizers, polyol benzoate plasticizers, or the combination thereof to the other plasticizers that is about 5:1 to about 1:5. Subsets of the foregoing range that may also be applicable include about 5:1 to about 1:1, about 2:1 to about 1:1, about 1:1 to about 1:5, about 1:1 to about 1:2, or about 2:1 to about 2:1. Described alternatively, if other plasticizers are included, the carbonate ester plasticizers, polyol benzoate plasticizers, or combination thereof may compose about 15% to about 85% by weight of the plasticizer, and the other plasticizers composes the remaining portion of the plasticizer (i.e., at about 85% to about 15% by weight of the plasticizer). Subsets of the foregoing ranges for either plasticizer portion that may also be applicable include about 15% to about 35%, about 65% to about 85%, about 25% to about 75%, about 50% to about 75%, or about 25% to about 50% by weight of the plasticizer.

Additional examples of plasticizers suitable for use in conjunction with a plasticized cellulose ester described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose esters in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional cellulose ester plasticizers like triacetin, has been observed to plasticize cellulose ester.

In some embodiments, the plasticizers may be food-grade plasticizers, which may be useful in producing a plasticized cellulose ester described herein for use in applications where the cellulose ester plastics may directly or indirectly contact food (e.g., food containers). Examples of food-grade plasticizers may, in some embodiments, include, but are not limited to, triacetin, diacetin, tripropionin, tribenzoin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, glycerol tribenzoate, polyethoxylated fatty alcohols, and the like, and any combination thereof.

In some embodiments, the plasticizers may be bio-derived, which may be useful in producing cellulose ester plastics that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some embodiments, cellulose esters of a plasticized cellulose ester described herein may have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination.

In some embodiments, cellulose esters of a plasticized cellulose ester described herein may have a degree of substitution of the ester substituent at about 0.5 to about 3. Subsets of the foregoing ranges that may also be applicable include about 0.5 to about 1.2, about 1.2 to about 2.5, about 2 to about 3, about 1.2 to about 2.7, about 0.5 to about 2.4, about 1.2 to about 2.4, or about 2.4 to about 3.

In some embodiments, cellulose esters of a plasticized cellulose ester described herein may have a molecular weight of about 10,000 to about 300,000. Subsets of the foregoing ranges that may also be applicable include about 10,000 to about 150,000, about 10,000 to about 100,000, about 10,000 to about 50,000, about 25,000 to about 300,000, about 25,000 to about 150,000, about 25,000 to about 100,000, about 25,000 to about 50,000, about 50,000 to about 300,000, about 50,000 to about 150,000, or about 50,000 to about 100,000. As used herein, the term “molecular weight” refers to a polystyrene equivalent number average molecular weight (Mₙ).

In some embodiments, cellulose esters of a plasticized cellulose ester described herein may have an intrinsic viscosity of about 0.5 dL/g to about 2.0 dL/g. Subsets of the foregoing ranges that may also be applicable include about 0.5 dL/g to about 1.7 dL/g, about 0.5 dL/g to about 1.3 dL/g, 1.0 dL/g to about 2.0 dL/g, or about 1.0 dL/g to about 1.7 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) \\ where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

In some embodiments, cellulose esters described herein may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), kudzu, and the like, and any combination thereof.

In some embodiments, the cellulose ester may be recycled from other cellulose ester materials. For example, cellulose acetate tow used in producing, for example, cigarette filters may be used for producing a plasticized cellulose ester described herein.

In some instances, fillers may optionally be used in a cellulose ester plastic described herein to increase the DTUL and improve other mechanical properties (e.g., increase the tensile strength and increase the elongation to break). Fillers may also be useful in increasing the room temperature tack of a cellulose ester plastic described herein. In some embodiments, fillers may be at about 5% to about 50% by weight of the cellulose ester plastic. Subsets of the foregoing ranges that may also be applicable include about 5% to about 40%, about 5% to about 30%, about 5% to about 15%, about 10% to about 50%, about 10% to about 25%, or about 25% to about 50% by weight of the cellulose ester plastic. In some instance, fillers may be excluded from the cellulose ester plastics described herein.

Fillers may, in some embodiments, increase the rigidity and decrease the creep of a cellulose ester plastic described herein, which may consequently increase the mechanical rigidity of an article produced therewith. Examples of fillers may include, but are not limited to, coconut shell flour, walnut shell flour, wood flour, wheat flour, soybean flour, gums, protein materials, calcium carbonate, talc, zeolite, clay, rigid compounds (e.g. lignin), thickeners, unreacted starches, modified starches (e.g., with modifications other than ester modifications like hydroxyethyl starch, hydrolyzed starch, cationic starch, starch phosphate, oxidized starch, and the like), waxy starches, cellulose nanofibrils, nanocrystalline cellulose, glass microspheres, glass fibers, carbonates, talc, silica, silicates, magnesium silicates, and the like, and any combination thereof.

In some embodiments, fillers suitable for use in conjunction with a cellulose ester plastic described herein may be food-grade fillers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Tackifying resins may be useful in increasing the room temperature tack of a cellulose ester plastic described herein. In some embodiments, tackifying resins may be at about 5% to about 50% by weight of the cellulose ester plastic. Subsets of the foregoing ranges that may also be applicable include about 5% to about 40%, about 5% to about 30%, about 5% to about 15%, about 10% to about 50%, about 10% to about 25%, or about 25% to about 50% by weight of the cellulose ester plastic.

Examples of tackifying resins suitable for use in conjunction with a cellulose ester plastic described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, rosin esters (SYLVATAC® RE85 and SYLVALITE® RE100, both esters of tall oil rosin, available from Arizona Chemical), shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl(meth)acrylates, acrylamides, N-(dialkyl amino alkyl) acrylamide, methacrylamides, hydroxy alkyl(meth)acrylates, methacrylic acids, acrylic acids, hydroxyethyl acrylates, ethylene vinyl acetate, vinyl acetate ethylene polymers, aliphatic hydrocarbons, cycloaliphatic hydrocarbons (e.g., EASTOTAC® products, available from Eastman Chemical Co.), aromatic hydrocarbons, aromatically modified aliphatic hydrocarbons, cycloaliphatic hydrocarbons, hydrogenated versions of the foregoing hydrocarbons, terpenes, polyterpenes, modified terpenes (e.g., phenolic modified terpene resins like SYLVARES™ TP96 and SYLVARES™ TP2040, available from Arizona Chemical), and the like, any derivative thereof, and any combination thereof.

In some embodiments, tackifiers suitable for use in conjunction with a cellulose ester plastic described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

In some embodiments, compatibilizers may be used to more homogeneously incorporate tackifying resins into a cellulose ester plastic described herein. Suitable compatibilizers may include those described above relative to the base polymer composition and may be used at similar concentrations.

In some instances, additives may be included in a cellulose ester plastic described herein. In some embodiments, additives may be at about 1% to about 40% by weight of the cellulose ester plastic. Subsets of the foregoing ranges that may also be applicable include about 1% to about 5%, about 1% to about 10%, about 5% to about 40%, about 5% to about 30%, about 5% to about 15%, about 10% to about 40%, about 10% to about 25%, or about 25% to about 40% by weight of the cellulose ester plastic.

Examples of additives suitable for use in conjunction with a cellulose ester plastic described herein may, in some embodiments, include, but are not limited to, plasticizers that plasticize a component of the cellulose ester plastic described herein other than the cellulose ester, antioxidants, pigments, viscosity modifiers, lubricants, softening agents, antibacterial agents, antifungal agents, preservatives, flame retardants, corrosion inhibitors, dehydrators, aromas, and the like, and combinations thereof.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

Viscosity modifiers may, in some embodiments, be advantageous in modifying the MFI of a cellulose ester plastic described herein and/or modify the viscosity of a cellulose ester plastic described herein. Viscosity modifiers suitable for use in conjunction with a cellulose ester plastic described herein may, in some embodiments, include, but are not limited to, polyethylene glycols, polypropylene glycols, glycerin, and the like, and any combination thereof, which, in some embodiments, may be a food-grade viscosity modifier.

Aromas suitable for use in conjunction with a cellulose ester plastic described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In some instances, a component of a cellulose ester plastic described herein may perform more than one function in the cellulose ester plastic. For example, BHT and BHA are both antioxidants and plasticizers for cellulose ester. Additionally, nonionic surfactants may, in some instances, function as both plasticizers and compatibilizers. In another example, aromas like eugenol, cinnamyl alcohol, camphor, methoxy hydroxy acetophenone (acetovanillone), vanillin, and ethylvanillin may also plasticize cellulose ester. In yet another example, benzoates and parabens (e.g., the propyl-4-hydroxybenzoate series) may be both preservatives and plasticizers for cellulose ester.

In some embodiments, a cellulose ester plastic described herein may be substantially water-free.

In some embodiments, a cellulose ester plastic described herein may be at least in part bio-derived compositions. In some embodiments, the amount of the cellulose ester plastic that is bio-derived may be about 2% to about 100% by weight of the cellulose ester plastic. Subsets of the foregoing ranges that may also be applicable include about 10% to about 99%, about 25% to about 95%, about 50% to about 99%, about 50% to about 95%, about 75% to about 99%, or about 90% to about 99% by weight of the cellulose ester plastic.

In some instances, cellulose ester plastics described herein may have a renewable content of about 20% to about 90%. As used herein, the term “renewable content” refers to the weight percent of components of a cellulose ester plastic that is mad from renewable sources such as plants. Subsets of the foregoing range that may also be applicable include about 20% to about 90%, about 20% to about 75%, about 50% to about 90%, about 70% to about 85%, about 70% to about 95%, or about 70% to about 99% by weight of the cellulose ester plastic.

### II. Properties

The physical and chemical properties of plasticized cellulose esters and thermoplastic polymers described herein may be tailored to achieve the desired characteristics of the cellulose ester plastics described herein. Examples of such properties may include, but are not limited to, the composition of the ester substituents of the cellulose esters, the degree of substitution of the ester substituent of the cellulose esters, the molecular weight of the cellulose esters, the composition of the plasticizers, the composition of the thermoplastic polymer, the molecular weight of the thermoplastic polymer, and the like, and any combination thereof. Further, the amount of plasticizer in the cellulose ester plastics described herein may be tailored to achieve the desired characteristics of the cellulose ester plastics.

The characteristics of the cellulose ester plastics described herein that can be tailored may include, but are not limited to, DTUL, tensile modulus, flow initiation temperature (an indicator of melt processing temperature), glass transition temperature, MFI, melt viscosity, impact strength, true density, degradability, clarity, yellowness index, and the like, and any combination thereof.

As described above, DTUL of a cellulose ester plastic may be used as an indicator of the temperature and load limitations for an article or component thereof formed with the cellulose ester plastic. Additionally, when forming an article, after the cellulose ester melt is extruded, injection molded, otherwise or formed into a desired shape, the cellulose ester plastic may be cooled below the DTUL for handling. The cooling step is an important step before handling so that the shape is not undesirably distorted. Therefore, in instances where the DTUL and the melt processing temperature are closer together, the amount of time or any additional steps needed to cool of the cellulose ester plastic below the DTUL may be reduced, which further enhances the processability of the cellulose ester plastics described herein.

In some embodiments, tailoring the DTUL of the cellulose ester plastics described herein may be achieved by, inter alia, changing the plasticizer concentration (e.g., decreasing the concentration to increase the DTUL), changing plasticizer composition (e.g., utilizing synergistic plasticization described above), changing the degree of substitution or composition of the cellulose ester, changing the molecular weight of the cellulose ester (e.g., increasing molecular weight to increase the DTUL), and changing the concentration of thermoplastic polymer in the base polymer (e.g., increasing thermoplastic polymer concentration to increase the DTUL).

DTUL, the temperature of deformation, can be measured by a three-point bending test under a variety of loads. Unless otherwise specified, as used herein, DTUL is measured by ISO 75-1/-2:2013 where the test specimen is tested via three-point bending with 0.45 MPa pressure or 1.8 MPa pressure. Unless otherwise specified, a 1.8 MPa pressure load is used. In some instances, the cellulose ester plastics described herein may have a DTUL at 0.45 MPa of about 30° C. to about 220° C. Subsets of the foregoing ranges that may also be applicable include about 30° C. to about 150° C., about 30° C. to about 110° C., about 50° C. to about 150° C., about 50° C. to about 110° C., about 70° C. to about 150° C., about 110° C. to about 200° C., 110° C. to about 150° C., or about 150° C. to about 220° C. In some instances, the cellulose ester plastics described herein may have a DTUL at 1.8 MPa of about 30° C. to about 220° C. Subsets of the foregoing ranges that may also be applicable include about 30° C. to about 150° C., about 30° C. to about 110° C., about 50° C. to about 150° C., about 50° C. to about 110° C., about 70° C. to about 150° C., about 110° C. to about 200° C., 110° C. to about 150° C., or about 150° C. to about 220° C.

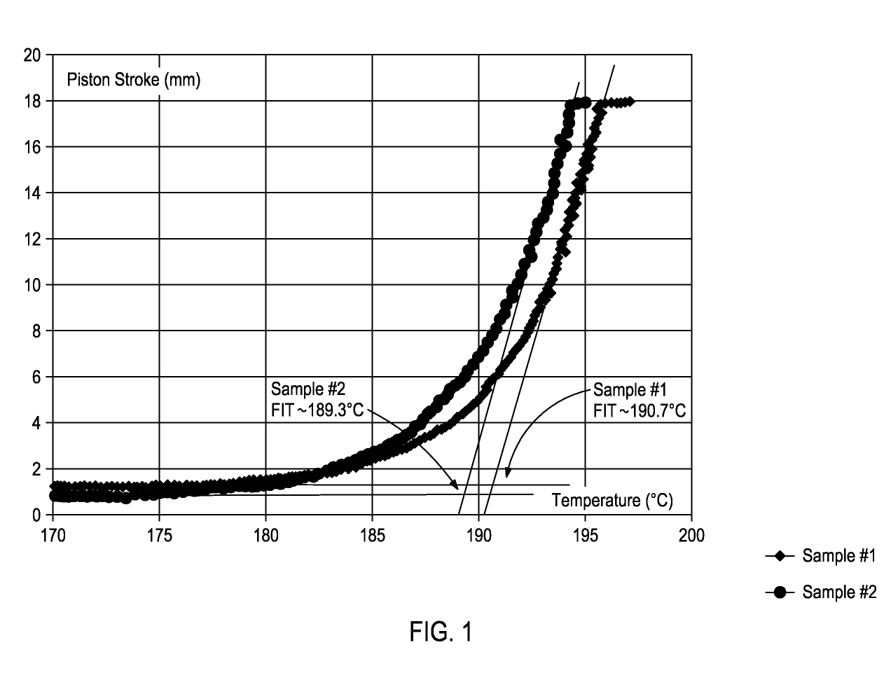

In some instances, a melting temperature is difficult to determine by differential scanning calorimetry. Therefore, the flow initiation temperature may be used to indicate the appropriate melt processing temperatures for the cellulose ester plastics described herein. Unless otherwise specified, as used herein the flow initiation temperature is measured with a capillary rheometer (e.g., a Shimadzu CFT-500D) using a constant heating-rate method at 4° C./min ramp rate, 100 kg force, and a 1 mm die. The resultant piston stroke-temperature plot (FIG. 1) may be used to determine the flow initiation temperature, which is the intersection of the tangent of the base line and the tangent of the final flow line as illustrated in FIG. 1 for two different samples.

In some embodiments, tailoring the flow initiation temperature of the cellulose ester plastics described herein may be achieved by, inter alia, changing the plasticizer concentration (e.g., increasing the concentration to decrease the flow initiation temperature), changing plasticizer composition, changing the degree of substitution or composition of the cellulose ester, changing the molecular weight of the cellulose ester (e.g., decreasing molecular weight to decrease the flow initiation temperature), and changing the concentration of thermoplastic polymer in the base polymer.

In some embodiments, the cellulose ester plastics described herein may have a flow initiation temperature of about 130° C. to about 230° C. Subsets of the foregoing range that may also be applicable include about 130° C. to about 210° C., about 130° C. to about 200° C., about 150° C. to about 230° C., about 150° C. to about 210° C., about 150° C. to about 200° C., about 180° C. to about 230° C., about 180° C. to about 210° C., about 180° C. to about 200° C., about 200° C. to about 230° C., or about 200° C. to about 210° C.

Tailoring the glass transition temperature of the cellulose ester plastics described herein may alter the physical characteristics of the cellulose ester plastics at ambient conditions, e.g., stiff or flexible, brittle or pliable, and the like, and any combination thereof. For example, cellulose ester plastics having higher glass transition temperatures may be more stiff and/or brittle than those having moderate to low glass transition temperatures. In some embodiments, tailoring the glass transition temperature of the cellulose ester plastics described herein may be achieved by, inter alia, changing the plasticizer concentration (e.g., increasing the concentration to decrease the glass transition temperature), changing the composition of the plasticizer, changing the molecular weight, changing the degree of substitution of the cellulose ester (e.g., in some instances, increasing the degree of substitution to increase the glass transition temperature), and changing the concentration of thermoplastic polymer in the base polymer.

In some embodiments, the cellulose ester plastics described herein may have a glass transition temperature of about 40° C. to about 180° C. Subsets of the foregoing range that may also be applicable include about 40° C. to about 150° C., about 40° C. to about 90° C., about 75° C. to about 180° C., 75° C. to about 150° C., about 75° C. to about 90° C., about 90° C. to about 180° C., 90° C. to about 150° C., or about 90° C. to about 125° C. The glass transition temperature of a cellulose ester plastic can be measured by either differential scanning calorimetry or rheology. One skilled in the art with the benefit of this disclosure would understand that the glass transition temperature value may fall outside the preferred range described herein for different plasticizers used to produce cellulose ester plastic samples. Accordingly, within the scope of the embodiments described herein, the glass transition can be manipulated based on the composition and concentration of cellulose esters, plasticizers, and additives included in the cellulose ester plastics.

Tailoring the MFI of cellulose ester plastics described herein may allow for using the cellulose ester plastics described herein in extrusion and injection molding methods. In some embodiments, tailoring the MFI of the cellulose ester plastics described herein may be achieved by, inter alia, changing the plasticizer composition, changing the plasticizer concentration (e.g., increasing the concentration to increase the MFI), changing the plasticizer composition (e.g., utilizing synergistic plasticization described above), changing the molecular weight of the cellulose ester (e.g., decreasing molecular weight to increase the MFI), changing the composition and/or concentration of additives (e.g., increasing crosslinker concentration to decrease the MFI), and changing the concentration of thermoplastic polymer in the base polymer.

In some embodiments, the cellulose ester plastics described herein may have a MFI (with a 300 sec melt time and at 210° C./2.16 kg measured in accordance with ASTM D1238) of about 0.1 g/10 min to about 75 g/10 min. Subsets of the foregoing range that may also be applicable include about 0.1 g/10 min to about 50 g/10 min, about 0.1 g/10 min to about 25 g/10 min, about 0.1 g/10 min to about 15 g/10 min, about 1 g/10 min to about 75 g/10 min, about 1 g/10 min to about 25 g/10 min, about 1 g/10 min to about 15 g/10 min, about 5 g/10 min to about 75 g/10 min, about 5 g/10 min to about 25 g/10 min, about 10 g/10 min to about 75 g/10 min, or about 10 g/10 min to about 25 g/10 min. It should be noted that the MFI of the cellulose ester plastics described herein may fall outside the ranges described herein depending on, inter alia, the additive (e.g., fillers, tackifiers, and the like), included in the plastic.

Tailoring the melt viscosity of cellulose ester plastics described herein may be useful for providing a cellulose ester plastic suitable for a specific extrusion or injection molding apparatus. In some embodiments, tailoring the melt viscosity of the cellulose ester plastics described herein may be achieved by, inter a/ia, changing the plasticizer composition, changing the plasticizer concentration (e.g., increasing the concentration to decrease the melt viscosity), changing the molecular weight of the cellulose ester (e.g., decreasing molecular weight to decrease the melt viscosity), changing the composition and/or concentration of additives (e.g., increasing crosslinker concentration to increase the melt viscosity), and changing the concentration of thermoplastic polymer in the base polymer.

The melt viscosity of cellulose ester plastics described herein may be measured by rheometers (rotational, or capillary). In some embodiments, the cellulose ester plastics described herein may have a melt viscosity at 210° C. and 1000 s⁻¹ of about 10 Pa*s to about 500 Pa*s. Subsets of the foregoing range that may also be applicable include about 10 Pa*s to about 300 Pa*s, about 10 Pa*s to about 150 Pa*s, about 50 Pa*s to about 500 Pa*s, about 50 Pa*s to about 300 Pa*s, about 50 Pa*s to about 150 Pa*s, about 100 Pa*s to about 500 Pa*s, about 100 Pa*s to about 300 Pa*s, or about 100 Pa*s to about 150 Pa*s. In some instances, lower melt viscosity may be preferable when melt processing plastics into articles.

Tailoring the Charpy impact strength of cellulose ester plastics described herein may be useful for producing articles for specific purposes where strength or lack thereof is important to the function of the article. In some embodiments, tailoring the Charpy impact strength of the cellulose ester plastics described herein may be achieved by, inter alia, changing the plasticizer composition, changing the plasticizer concentration (e.g., decreasing the concentration to decrease the impact strength), changing the molecular weight of the cellulose ester (e.g., decreasing molecular weight to decrease the impact strength), changing the composition and/or concentration of additives (e.g., increasing crosslinker concentration to increase the impact strength), and changing the concentration of thermoplastic polymer in the base polymer.

The Charpy impact strength of cellulose ester plastics described herein may be measured by ISO 179-1:2010. In some embodiments, the cellulose ester plastics described herein may have a Charpy impact strength of about 1 kJ/m² to about 50 kJ/m². Subsets of the foregoing range that may also be applicable include about 1 kJ/m² to about 30 kJ/m², about 1 kJ/m² to about 20 kJ/m², 5 kJ/m² to about 50 kJ/m², 5 kJ/m² to about 30 kJ/m², about 5 kJ/m² to about 20 kJ/m², 10 kJ/m² to about 50 kJ/m², 10 kJ/m² to about 40 kJ/m², about 10 kJ/m² to about 30 kJ/m², 20 kJ/m² to about 50 kJ/m², or 20 kJ/m² to about 40 kJ/m².

The tensile modulus of cellulose ester plastics described herein may be measured by ISO 527-1:2012. In some embodiments, the cellulose ester plastics described herein may have a tensile modulus of about 1000 MPa to about 7000 MPa. Subsets of the foregoing range that may also be applicable include about 1000 MPa to about 5000 MPa, about 1000 MPa to about 3000 MPa, 2000 MPa to about 7000 MPa, 2000 MPa to about 5000 MPa, about 3000 Mpa to about 7000 Mpa, or about 4000 MPa to about 7000 MPa.

The flexural modulus of cellulose ester plastics described herein may be measured by ISO 178:2010. In some embodiments, the cellulose ester plastics described herein may have a tensile modulus of about 1000 MPa to about 8000 MPa. Subsets of the foregoing range that may also be applicable include about 1000 MPa to about 5000 MPa, about 1000 MPa to about 3000 MPa, 2000 MPa to about 8000 MPa, 2000 MPa to about 5000 MPa, about 3000 Mpa to about 8000 Mpa, or about 4000 MPa to about 8000 MPa.

Additional mechanical properties of the cellulose ester plastics that may also be maintained or improved may include, but are not limited to, tensile strength break as measured by break stress, tensile strength as measured by yield stress, flexural strength at 3.5% stress, elongation at break, elongation at yield, and IZOD notched strength.

The true density of a cellulose ester plastic described herein may be measured by ISO 1183-1:2012. In some embodiments, a cellulose ester plastic described herein may have a true density of about 1.2 to about 1.3. This is a much lower density than other synthetic polymers (e.g., ethylene vinyl acetate copolymer and polysiloxanes), which may allow for producing light-weight articles or components thereof.

Because cellulose esters are degradable, the products and article produced therefrom may also have some level of degradability. Tailoring the degradability of cellulose ester plastics described herein may contribute to the overall degradability of products and articles comprising the cellulose ester plastics. In some embodiments, tailoring the degradability of the cellulose ester plastics described herein may be achieved by, inter alia, changing the plasticizer composition (e.g., utilizing a plasticizer that biodegrades or dissipates into the environment at a higher rate to increase the degradability), changing the plasticizer concentration (e.g., increasing the concentration to increase the degradability), changing the degree of substitution of the cellulose ester (e.g., decreasing the degree of substitution to increase the degradability), changing the composition and/or concentration of additives (e.g., increasing antioxidant and/or stabilizer concentration to decrease the degradability), and changing the concentration of thermoplastic polymer in the base polymer (e.g., decreasing the concentration to increase the degradability).

Because the synergistic plasticization allows for lower processing temperatures, the yellowing of the cellulose ester plastic that occurs as the cellulose ester decomposes may be mitigated. Accordingly, the synergistic plasticization may provide for a lower yellowness index. The yellowness index may be measured according to ASTM E313-10. In some embodiments, the cellulose ester plastics described herein may have a yellowness index of approaching 0 to approaching 100. Subsets of the foregoing range that may also be applicable include about 1 to about 75, about 1 to about 50, about 1 to about 40, about 5 to about 75, about 5 to about 50, about 20 to about 75, about 20 to about 40, about 25 to about 75, or about 25 to about 50.

The clarity of the cellulose ester plastics described herein may be important in some applications (e.g., high clarity (or low haze) may be useful in food packaging, mobile phone enclosures, and the like). The haze of an cellulose ester plastics can be measured with properly sized specimens having substantially plane-parallel surfaces (e.g., flat without wrinkling) free of dust, scratches, particles and a thickness of about 0.85 mm using an UtraScan Pro from Hunter Lab with D65 Illuminant/10° observer.

In some embodiments, the cellulose ester plastics described herein may have a haze of about 2 to about 45. Subsets of the foregoing range that may also be applicable include about 2 to about 35, about 2 to about 25, about 10 to about 45, about 10 to about 40, about 10 to about 25, about 25 to about 45, about 25 to about 35, about 7 to about 25, or about 5 to about 25. One skilled in the art with the benefit of this disclosure would understand that the haze value may fall outside the preferred ranges described herein for different thickness of a cellulose ester plastic sample. In some instances, the haze value may be significantly larger than the preferred ranges above (e.g., about 100) when additives like titanium dioxide are used in significant quantities to produce an opaque cellulose ester plastic. Additionally, pigments and dyes may affect the haze of the cellulose ester plastics. Accordingly, within the scope of the embodiments described herein, the haze may range from about 2 to about 100, including subsets therebetween, depending on the composition and concentration of additives included in the cellulose ester plastics.

### III. Methods

Some embodiments described herein may involve producing cellulose ester plastics described herein, which may involve mixing (e.g., compounding, blending, high-shear mixing, etc.) plasticized cellulose esters, thermoplastic polymers, optional compatibilizers, optional a tackifying resin, and optional additives (e.g., fillers, antioxidants, and the like, and combinations thereof) at suitable concentrations and heating to form a blend. Some embodiments may involve mixing the base polymer (e.g., blending the plasticized cellulose esters with the thermoplastic polymers, blending together the cellulose esters, the plasticizers, and the thermoplastic polymers, or blending the cellulose esters and the plasticizers) and heating to form a base polymer blend. Then the optional compatibilizers, the optional tackifying resin, and the optional additives at suitable concentrations may be mixed with the base polymer blend.

Optionally, producing the cellulose ester plastics, the base polymer, or the plasticized cellulose ester described herein may include an aging step where the corresponding blend is allowed to sit (e.g., about 15 minutes to about 1 day) at an elevated temperature (e.g., at or above the flow initiation temperature of the composition) to allow for the plasticizer to diffuse through the cellulose ester and associate with individual cellulose ester molecules. This may be useful in producing a more homogeneous mixture. After the aging step, the blend may be mixed again, heated to produce a melt, and formed into (1) a desired shape for producing an article or component thereof or (2) pellets or sheets that may be further processed (e.g., via a melt for the pellets or thermoforming for the sheets) into a desired shape for producing an article or component thereof. It should be noted that the term “sheet” should not be interpreted to be limited in thickness and encompasses films, layers, and the like.

Forming the melt of cellulose ester plastic into a desired shape (e.g., for producing an article or pellets or sheets) may involve at least one of injection molding, extruding (e.g., blow molding, thermoforming, film/sheet extrusion, wire coating, pipe extrusion, and the like), compression molding, rotomolding, die casting, and the like. Generally, the temperatures used in producing melts and forming a desired shape are below the temperature at which the cellulose ester degrades. These temperature may, in some instances, be about 190° C. to about 240° C.

The articles or components thereof may be formed by a plurality of methods including, but not limited to, injection molding, extruding, compression molding, rotomolding, or die casting. The melt processing of the cellulose ester plastics described herein may be sufficiently depressed relative to the degradation temperature of the cellulose ester and the melt flow properties may be acceptable so that injection molding techniques may be advantageously used up to about 240° C.

In some instances, articles that require the enhanced DTUL and mechanical properties of the cellulose ester plastics described herein also require that the articles have a low volatility. That is, less than 2% of the weight of the cellulose ester plastic is volatilized when exposed to 110° C. for 24 hours. The “percent weight loss” is calculated as follows:

(weight before 110° C. for 24 hours)−(weight after 110° C. for 24 hours)/(weight before 110° C. for 24 hours)*100

### IV. Articles

Exemplary articles that utilize the enhanced DTUL and mechanical properties of the cellulose ester plastics described herein may include, but are not limited to, vehicle interior parts (e.g., door handles, cup holders, dashboards, and glove boxes), appliance components, food and beverage containers, food and beverage container lids, electrical and electronic device enclosures (e.g., computer monitor enclosures, laptop enclosures, cellular phone enclosures), and the like. electrical and electronic device enclosures (e.g., computer monitor enclosures, laptop enclosures, cellular phone enclosures), and the like.

Advantageously, at least some of the polyol benzoates have a low volatility and, therefore, are useful in producing article with a low volatility.

While the enhanced DTUL and mechanical properties are advantageous, the cellulose ester plastics described herein may be used in other articles where such enhancements may be useful but are not necessarily required. Examples of such articles may include, but are not limited to, containers and components thereof (e.g., frozen dinner containers, bottles, disposable plastic containers, lids, caps, trash cans, drawer inserts, decorative boxes, medicine bottles, and the like), furniture or components thereof (e.g., headboards, chairs, stools, and the like), picture frames, dartboards, light filters, eye glass frames, medical devices and components thereof (e.g., syringes, housings for medical devices like blood glucose meters, tongue depressors, clamps, and the like), valves, remote control housings, electrical and electronic device enclosures (e.g., computer monitor enclosures, laptop enclosures, cellular phone enclosures), and the like. electrical and electronic device enclosures (e.g., computer monitor enclosures, laptop enclosures, cellular phone enclosures), buttons, planters, and the like.

Because of the environmentally-friendly aspects of cellulose ester plastics, articles produced therefrom may advantageously be articles with a short consumer lifetime that can then be recycled (e.g., food containers, bottles, disposable medical devices, and the like).

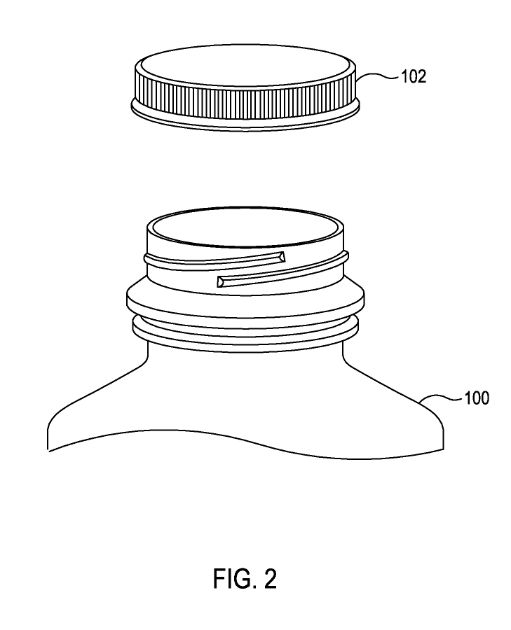

By way of nonlimiting example, FIG. 2 illustrates a bottle 100 with a cap 102 where each may independently be formed by a cellulose ester plastic described herein.

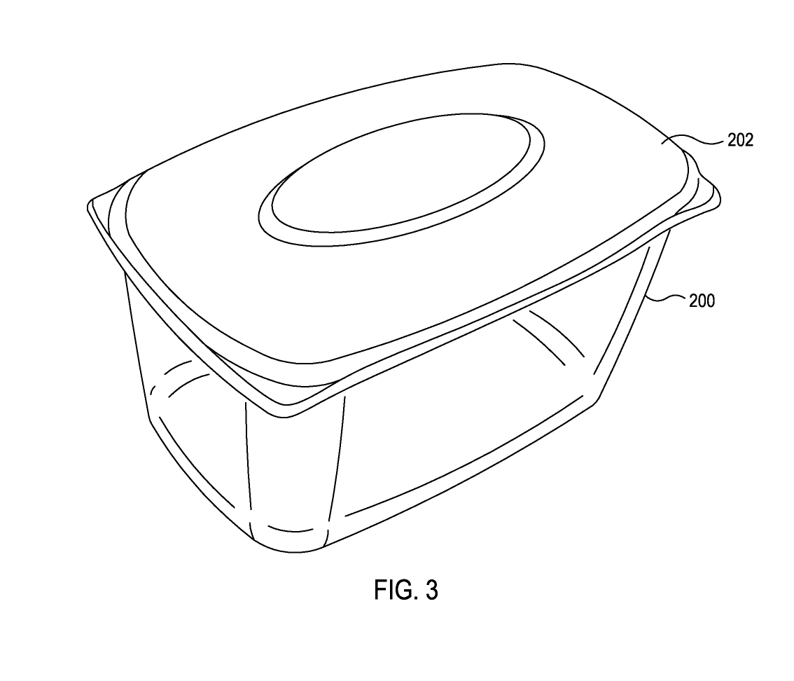

By way of another nonlimiting example, FIG. 3 illustrates a food container 200 with a lid 202. In some instances, the food container 200, the lid 202, or both may be formed by a cellulose ester plastic described herein. Because of the DTUL improvements described herein, such food containers and lids may be reusable since they may withstand the temperatures and stresses of a dishwasher.

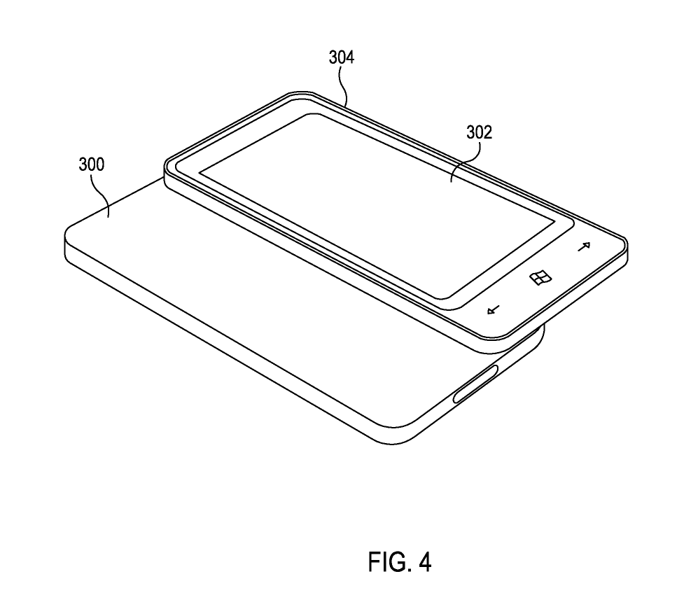

By way of yet another nonlimiting example, FIG. 4 illustrates a mobile phone 304 with a protective cover 300 and screen cover 302. In some instances, the protective cover 300, the screen cover 302, or both may be formed by a cellulose ester plastic described herein. Because of the DTUL improvements described herein, the cellulose ester plastic may have sufficient resiliency and dimensional stability to effectively perform as a protective cover 300. This exemplary protective cover 300 and screen cover 302 may be translated to other electronics like MP3 players, laptops, speakers, and the like.

Embodiments described herein include:
Embodiment A: a cellulose ester plastic comprising: a plasticized cellulose ester at about 1% to about 99% by weight of the cellulose ester plastic, the plasticized cellulose ester consisting of a cellulose ester at about 60% to about 90% by weight of the plasticized cellulose ester and a plasticizer at about 10% to about 40% by weight of the plasticized cellulose ester, wherein the plasticizer comprises a carbonate ester, a polyol benzoate, or both; and a thermoplastic polymer at about 1% to about 99% by weight of the cellulose ester plastic; and wherein the cellulose ester plastic is melt processable;
Embodiment B: a plasticized cellulose ester consisting of: a cellulose ester at about 80% to about 90% by weight of the plasticized cellulose ester; and a plasticizer at about 10% to about 20% by weight of the plasticized cellulose ester, wherein the plasticized cellulose ester is melt processable; and
Embodiment C: a method comprising injection molding a cellulose ester plastic of Embodiment A or a plasticized cellulose ester of Embodiment B at about 190° C. to about 240° C. to form an injection molded article.

Embodiments A, B, and C may optionally include at least one of the following elements: Element 1: wherein the plasticizer comprises a carbonate ester, a polyol benzoate, or both; Element 2: Element 1 and wherein the plasticizer further comprises at least one other plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and any combination thereof; Element 3: Element 2 and wherein the plasticizer consists of about 15% to about 85% of the carbonate ester, the polyol benzoate, or both and about 15% to about 85% of the other plasticizer; Element 4: Element 2 and wherein the plasticizer consists of about 50% to about 75% of the carbonate ester, the polyol benzoate, or both and about 25% to about 50% of the other plasticizer; Element 5: the cellulose ester plastic further comprising a compatibilizer at about 0.1% to about 20% by weight of the cellulose ester plastic; Element 6: wherein the plasticizer comprises at least one carbonate ester selected from the group consisting of: propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, and phenyl tridecyl carbonate; and Element 7: wherein the plasticizer comprises at least one polyol benzoate selected from the group consisting of: glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, and sucrose benzoate. Exemplary combinations may include: Element 1 in combination with Element 5; Elements 1-2 in combination with Element 5; Elements 1-3 in combination with Element 5; and Elements 1, 2, and 4 in combination with Element 5; Element 6 and/or Element 7 in combination with any of the foregoing; Element 6 and/or Element 7 in combination with Element 1 and optionally one or more of Elements 2-4; or Element 6 and/or Element 7 in combination with Element 5.

To facilitate a better understanding of the embodiments described herein, the following examples of preferred or representative embodiments are given. In no way should the following examples be read to limit, or to define, the scope of the disclosure.

### EXAMPLES

Example 1 illustrates that the carbonate ester and polyol benzoate plasticizers described herein enhance the DTUL of cellulose ester plastics. Various cellulose ester plastic samples using different plasticizers and plasticizer concentrations were compounded at about 210° C. to about 240° C. according to the formulations in Table 1. ISO 75-1/-2:2013 was used to measure DTUL at the given loads.

TABLE 1

| | | | DTUL | DTUL | | | Charpy |
|---|---|---|---|---|---|---|---|
| | Cellulose | | at | at | Tensile | Flexure | Impact |
| | Acetate | Plasticizer | 1.8 MPa | 0.45 MPa | Modulus | Strength | Strength |
| Sample | (wt %) | (wt %) | (° C.) | (° C.) | (MPa) | (MPa) | (kJ/m²) |
| 1 | 78% | 22% GTB | 85 | 111 | 4191 | 4355 | 1.8 |
| 2 | 75% | 25% GTB | 77 | 97 | 3507 | 3794 | 1.9 |
| 3 | 72% | 28% GTB | 70 | 90 | 3074 | 3253 | 1.7 |
| 4 | 85% | 15% PRC | 94 | 113 | 5631 | 6792 | 15 |
| 5 | 80% | 20% PRC | 75 | 91 | 4302 | 5412 | 12.8 |
| 6 | 77% | 23% PRC | 61 | 76 | 4320 | 4789 | 11.9 |
| 7 | 74% | 26% PRC | 58 | 67 | 3425 | 3873 | 15.6 |
| 8 | 71% | 29% PRC | 51 | 59 | 3066 | 3246 | 16.4 |
| 9 | 82% | 18% DPC | 92 | 113 | 4228 | 4851 | 4.6 |
| 10 | 80% | 20% DPC | 79 | 105 | 4248 | 4499 | 4.8 |
| 11 | 78% | 22% DPC | 79 | 99 | 3804 | 4179 | 6.4 |
| 12 | 74% | 26% DPC | 65 | 84 | 2290 | 3265 | 8.7 |
| 13* | 84% | 17% TA | — | — | — | — | — |
| 14 | 77% | 23% TA | 70 | — | 2993 | 3375 | 8.1 |
| 15 | 74% | 26% TA | 61 | — | 2857 | 3223 | 10.3 |
| 16 | 72% | 28% TA | 59 | — | 2733 | 3027 | 8.6 |
| 17 | 67% | 33% TA | 40 | — | 1503 | 1596 | 15.1 |
| 18 | 74% | 26% TEC | 59 | — | 2396 | 2456 | 9.1 |
| 19 | 72% | 28% TEC | 49 | — | 2050 | 2152 | 10 |
| 20 | 78% | 22% DEP | 62 | 85 | 2857 | 2895 | 1.3 |
| 21 | 74% | 26% DEP | 57 | 72 | 2285 | 2436 | 5.1 |
| 22 | 72% | 28% DEP | 60 | 76 | 2347 | 2500 | 12.0 |
| 23 | 70% | 30% DEP | 57 | 74 | 1994 | 1972 | 17.6 |
| 24 | 68% | 32% DEP | 61 | — | 2179 | 2033 | 19.8 |
| 25 | 66% | 34% DEP | 46 | 58 | 1543 | 1565 | 19.8 |
| 26 | 74% | 26% ATEC | 66 | 85 | 2411 | 2612 | 8.0 |
| 27 | 72% | 14% TA | 56 | — | 2298 | 2098 | 12.8 |
| | | 14% TEC | | | | | |
| 28 | 72% | 18% TA | 53 | — | 2123 | 2139 | 11.9 |
| | | 10% TEC | | | | | |
| 29 | 72% | 18% TA | 54 | — | 2167 | 2078 | 12.25 |
| | | 7% TEC | | | | | |
| | | 3% ATEC | | | | | |
| 30 | 75% | 15% GTB | 69 | — | 3223 | 3394 | 2.3 |
| | | 10% TA | | | | | |
| 31 | 75% | 10% GTB | 70 | — | 3076 | 3216 | 3.2 |
| | | 15% ATEC | | | | | |
| 32 | 71% | 15% PRC | — | 62 | 2447 | 2649 | 13.2 |
| | | 14% TA | | | | | |
| 34 | 71% | 10% PRC | — | 67 | 2615 | 2711 | 11.5 |
| | | 19% TA | | | | | |
| 34 | 71% | 15% PRC | — | 69 | 2448 | 2617 | 12 |
| | | 14% ATEC | | | | | |
| 35 | 71% | 15% PRC | — | 76 | 2769 | 2907 | 3.6 |
| | | 14% GTB | | | | | |
| 36 | 65% | 15% PRC | — | 47 | 1892 | 1544 | 17.4 |
| | | 20% TA | | | | | |
| 37 | 65% | 15% PRC | — | 55 | 1639 | 1430 | 17.3 |
| | | 20% ATEC | | | | | |

— = not measured
*= not melt processable
CA = cellulose acetate
GTB = glyceryl tribenzoate
PRC = propylene carbonate
DPC = diphenyl carbonate
TA = triacetin
TEC = triethyl citrate
DEP = diethyl phthalate
ATEC = acetyl triethyl citrate

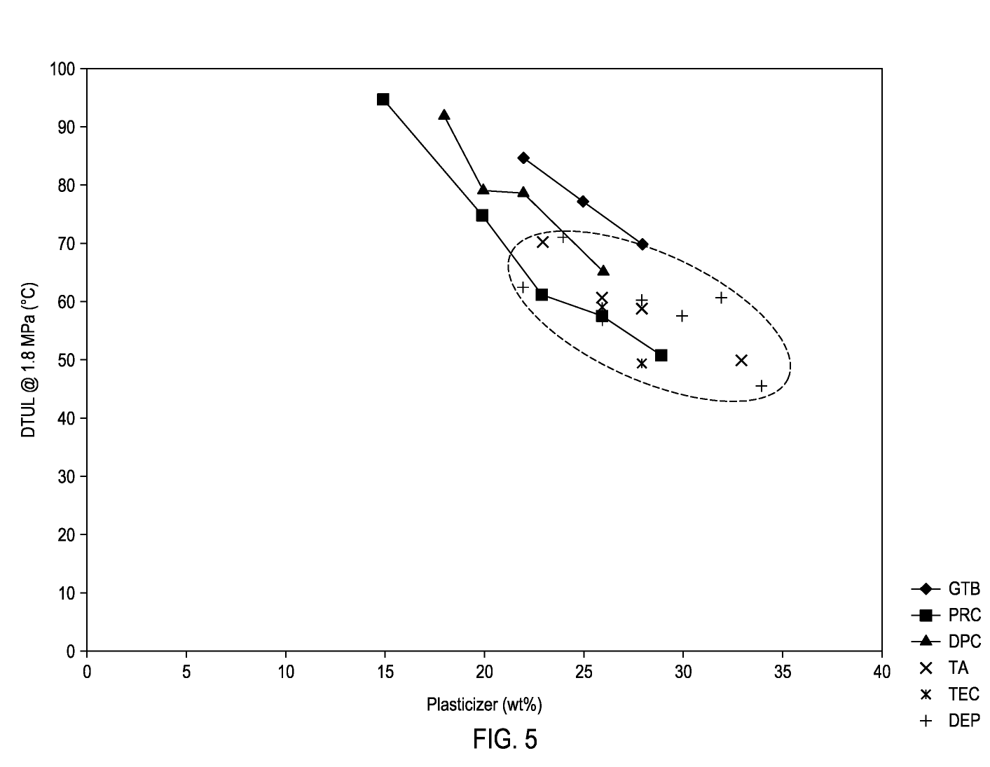

FIG. 5 is a plot of DTUL at 1.8 MPa versus the percent plasticizer for Samples 1-25 where a single plasticizer is used. The graph illustrates as plasticizer concentration increase, the DTUL decrease. Further, the traditional plasticizers have DTUL below about 70° C. and have a minimum plasticizer concentration of about 20%. As illustrated in Sample 13 of Table 1, plasticizer concentrations below 20% are not melt processable. Visually, these low concentrations of traditional plasticizers form samples that are brittle and cannot form pellets by the method described herein to be considered melt processable.

The carbonate ester and polyol benzoate plasticizers tested increased the DTUL by either being a more effective plasticizer in allowing for less concentration of plasticizer while still forming a melt processable sample or by increasing thermal performance at equivalent plasticizer levels.

Table 1 also includes mixed plasticizer samples where the use of carbonate ester and/or polyol benzoate plasticizers increases the DTUL of the sample. For example, Sample 15 with 26% triacetin had a DTUL at 1.8 MPa of about 61° C., which was raised almost 15% by replacing a portion of the triacetin with glyceryl tribenzoate in Samples 29 and 30. Another example, sample 8 with 29% PRC had a DTUL at 1.8 MPa of about 56° C. which was raised almost 29% by replacing a portion of the PRC with glyceryl tribenzoate in Samples 35.

In addition to increasing the DTUL, the propylene carbonate also increased the impact strength of the cellulose ester plastics by an order of magnitude as compared to comparable concentrations of other plasticizers.

Example 2 illustrates that the polyol benzoate plasticizers produce cellulose ester plastics with low volatility. Various plasticized cellulose acetate samples were compounded at about 190° C. to about 240° C. according to the formulations in Table 2. To measure the weight loss due to volatilization of the plasticizer, 20 g of each cellulose acetate plastic sample was first dried at room temperature in a desiccator for at least 48 hours. The weight after desiccation was recorded as the original weight. Then, the samples were exposed to 110° C. in an oven for 24 hours. As the samples were removed from the oven, they were placed back in the desiccator to cool and mitigate moisture uptake before obtaining a final weight. The weight loss during the heat treatment provides an indication of the volatility of the plasticizer in each formulation. The test were performed in triplicate with the average percent weight loss results provided in Table 2.

TABLE 2

| | Sample | | | | | |
|---|---|---|---|---|---|---|
| | 37 | 38 | 39 | 40 | 41 | 42 |
| CA (wt %) | 74 | 75 | 77 | 75 | 68 | 74 |
| GTB (wt %) | 0 | 15 | 15 | 25 | 25 | 0 |
| ATEC (wt %) | 0 | 10 | 8 | 0 | 0 | 26 |
| PEG-300 (wt %) | 0 | 0 | 0 | 0 | 7 | 0 |
| TA (wt %) | 26 | 0 | 0 | 0 | 0 | 0 |
| % Weight Loss | >2.0 | 0.51 | 0.41 | 0.10 | 0.13 | 0.63 |

PEG-300 = polyethylene glycol 300 molecular weight

Sample 37 is a formulation with a common, volatile plasticizer, triacetin and has the highest weight loss in this test. Increasing the concentration of glyceryl tribenzoate in the formulation decreases the percent weight loss, which would provide for the plasticized cellulose acetate (and consequently a cellulose ester plastic and/or article produced therefrom) to better retain its mechanical properties and DTUL over time, especially, when experiencing increased temperatures. Further, Samples 38-42 have a low volatility, which may render these samples suitable for inclusion in vehicle interior parts.

Example 3 illustrates cellulose ester plastics that include a polyolefin, specifically polypropylene, in the formulation. Various cellulose ester plastic samples were prepared with polypropylene according to the formulations in Table 3, wherein Sample 43 with no polypropylene and Sample 47 with 100% polypropylene provide comparison standards for the other samples. The methods used to measure the mechanical properties included: ISO 527-1:2012—tensile modulus, yield stress, yield strain, break stress, break strain; ISO 178:2010—flexural modulus; ISO 179-1:2010—Charpy impact strength (notched); ISO 75-1/-2:2013—DTUL at 1.8 MPa, ISO 1133—MFI (at 210° C., 2.16 kg); and Method in Example 2—% weight loss.

TABLE 3

| | Sample | | | | | | | |
|---|---|---|---|---|---|---|---|---|
| | 43 | 44 | 45 | 46 | 47 | 48 | 49 | 50 |
| PP (wt %) | 0 | 50 | 70 | 80 | 100 | 66.5 | 68.6 | 75 |
| CA (wt %) | 75 | 37.5 | 22.5 | 15 | 0 | 21.4 | 22.1 | 18.8 |
| GTB (wt %) | 25 | 12.5 | 7.5 | 5 | 0 | 7.1 | 7.3 | 3.8 |
| ATEC (wt %) | 0 | 0 | 0 | 0 | 0 | 0 | 0 | 2.5 |
| PEG-300 (wt %) | 0 | 0 | 0 | 0 | 0 | 5 | 2 | 0 |
| Tensile Modulus (MPa) | 3570 | 1442 | 1267 | 1135 | 1122 | 1135 | 1104 | 1101 |
| Yield Stress (MPa) | 99 | 0 | 0 | 0 | 21 | 18 | 13 | 15 |
| Yield Strain (%) | 5 | 0 | 0 | 0 | 5 | 4 | 3 | 3 |
| Break Stress (MPa) | 86 | 20 | 21 | 17 | 16 | 17 | 13 | 15 |
| Break Strain (%) | 4 | 2 | 4 | 4 | 31 | 6 | 4 | 4 |
| Flexural Modulus (MPa) | 4000 | 1637 | 1379 | 1205 | 1109 | 1144 | 1232 | 1123 |
| Charpy Impact | 3.1 | 4.6 | 5.1 | 6.5 | 7.7 | 7.1 | 11.2 | 9.1 |
| Strength (kJ/m²) | | | | | | | | |
| DTUL at 1.8 MPa (° C.) | 82 | 62 | 67 | 60 | 53 | 51 | 57 | 58 |
| MFI (g/10 min) | 2 | 0.43 | 0 | 7.16 | 21.1 | 23.21 | 8.09 | — |
| % Weight Loss | 0.3 | 0.17 | 0.18 | 0.19 | — | 0.26 | 0.24 | 0.41 |

PP = polypropylene

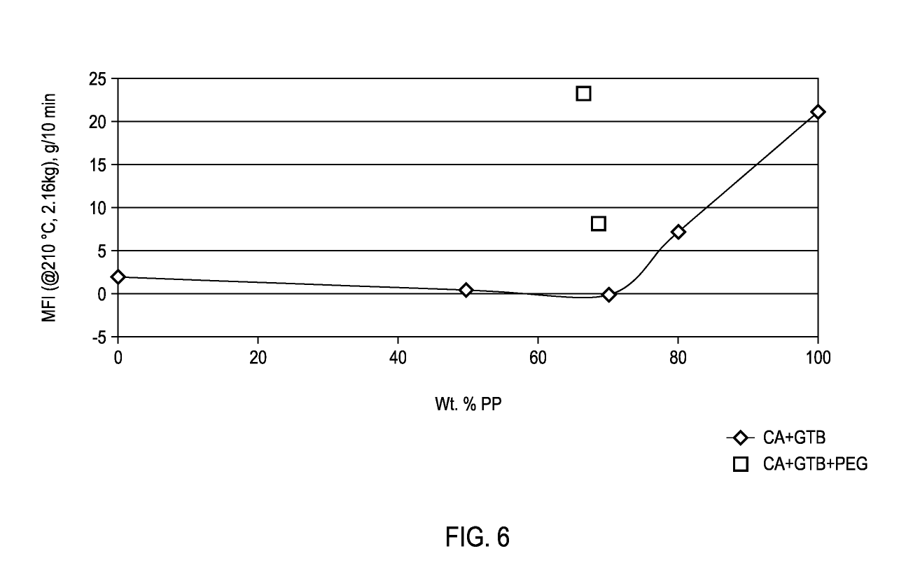

FIGS. 6-8 plot the MFI, Charpy impact strength, and % weight loss, respectively, as a function of the percent polypropylene for the foregoing samples.

FIG. 6 illustrates that the MFI increases significantly at higher polypropylene concentrations, which indicates the cellulose ester plastic is more flowable. Further, when polyethylene glycol is used as a compatibilizer, the MFI increases significantly to be comparable to polypropylene alone even with almost 33% plasticized cellulose ester included by weight of the cellulose ester plastic.

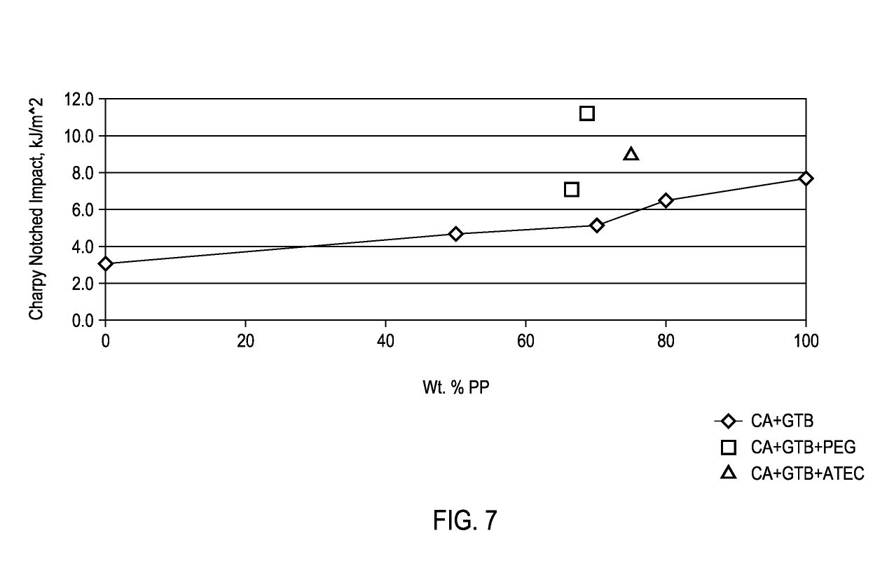

FIG. 7 illustrates that the Charpy impact strength (greater values indicate tougher materials) increases with increasing polypropylene concentration. However, when a compatibilizer like polyethylene glycol added, the cellulose ester plastics have comparable or better toughness than native polypropylene.

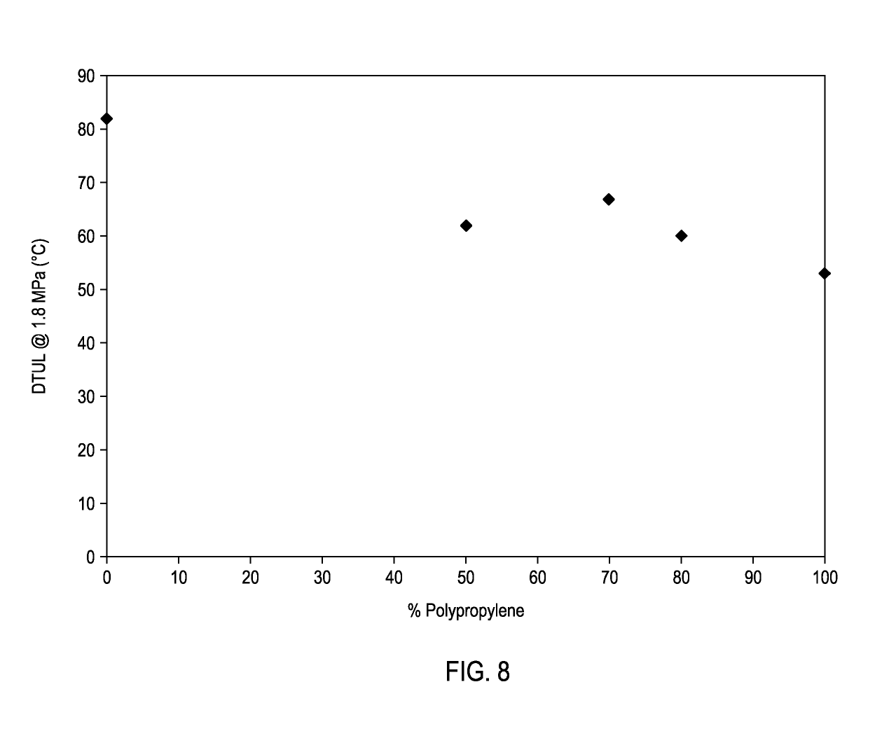

FIG. 8 illustrates that the DTUL increases with increasing plasticized cellulose acetate concentration and decreasing polypropylene concentration.

Example 3 illustrates that cellulose ester plastics comprising cellulose esters, polyol benzoates, and polypropylene are comparable to or can outperform polypropylene. Further, such formulations can be more environmentally-friendly with renewable contents of 25% or higher, in some instances.

Example 4. Seven plastic samples were prepared with compositions according to Table 4 (percentages by weight of the final composition) using plasticized cellulose acetate, polypropylene (SC8202N grade available from LyondellBasell), and compatibilizer (300 molecular weight polyethylene glycol). The plasticized cellulose acetate was prepared by compounding about 33% by weight triacetin, about 0.42% antioxidant, and the balance cellulose acetate (about 2.41 degree of substitution and about 1.6 intrinsic viscosity). The compounded material was aged for about 4-6 hours at 80° C. The resultant material was compounded and extruded into pellets (about 200° C. to about 220° C. at the die and about 180° C. to about 190° C. at the other zones). The resultant pellets were dried for about 2 hours at about 80° C. and, then, tumble mixed with the polypropylene and the compatibilizer in the Table 1 amounts for about 15 to about 20 minutes. Finally, the mixture was compounded and extruded as described above.

TABLE 4

| | Base Polymer | | | |
|---|---|---|---|---|
| | Plasticized | | | |
| | Cellulose | | | |
| | Acetate | Polypropylene | Compatibilizer | |
| | (wt % base | (wt % base | (wt % total | |
| Sample | polymer) | polymer) | composition) | MFI |
| 51 | 100 | 0 | 0 | 12 |
| 52 | 0 | 100 | 0 | 21.1 |
| 53 | 20 | 80 | 0 | 15.2 |
| 54 | 25 | 75 | 0 | 20.61 |
| 55 | 25 | 75 | 3 | 43 |
| 56 | 25 | 75 | 5 | 39 |
| 57 | 50 | 50 | 3 | 65 |

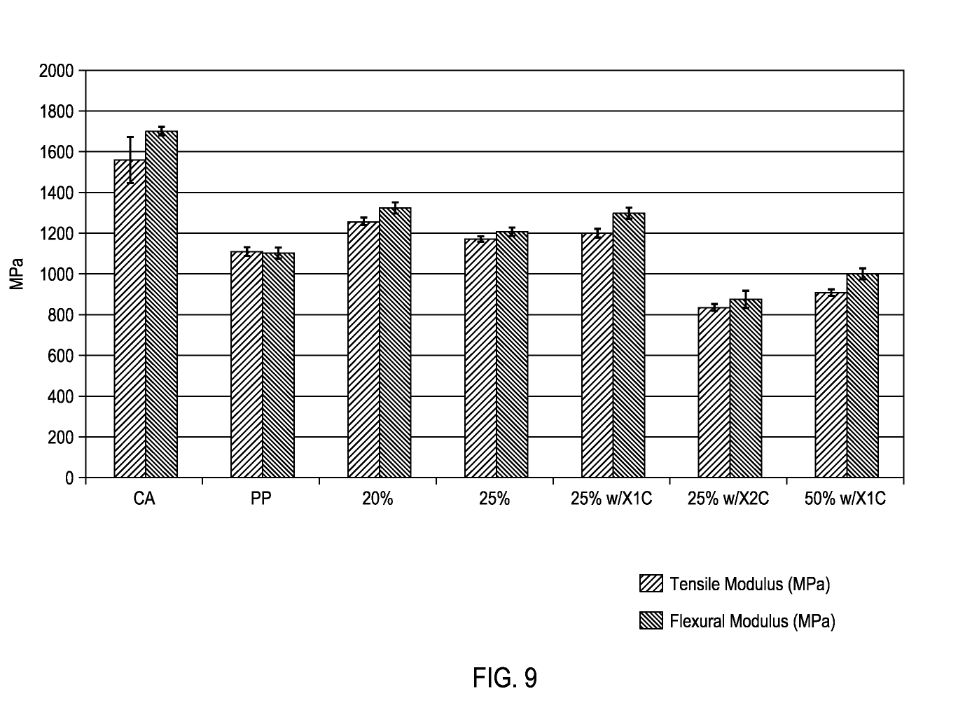

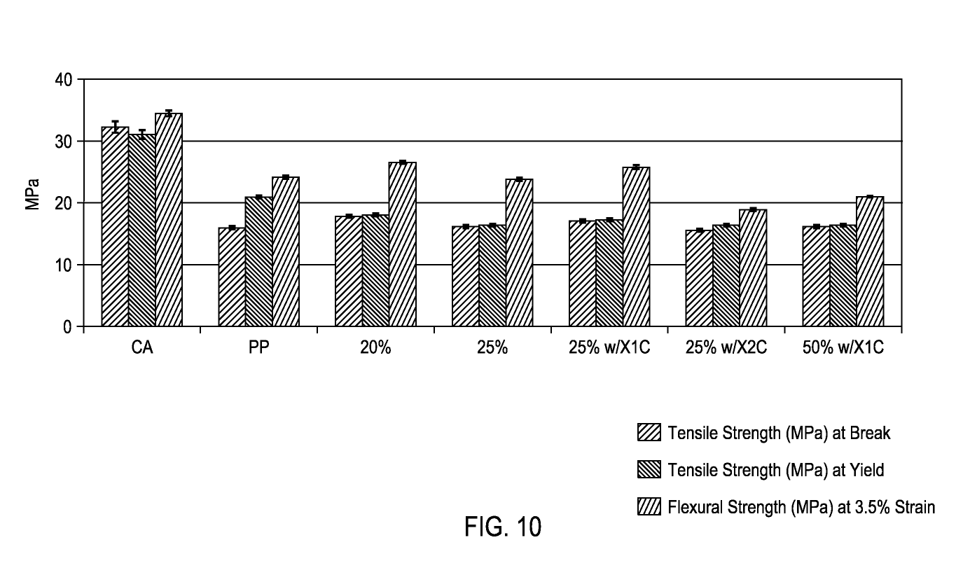

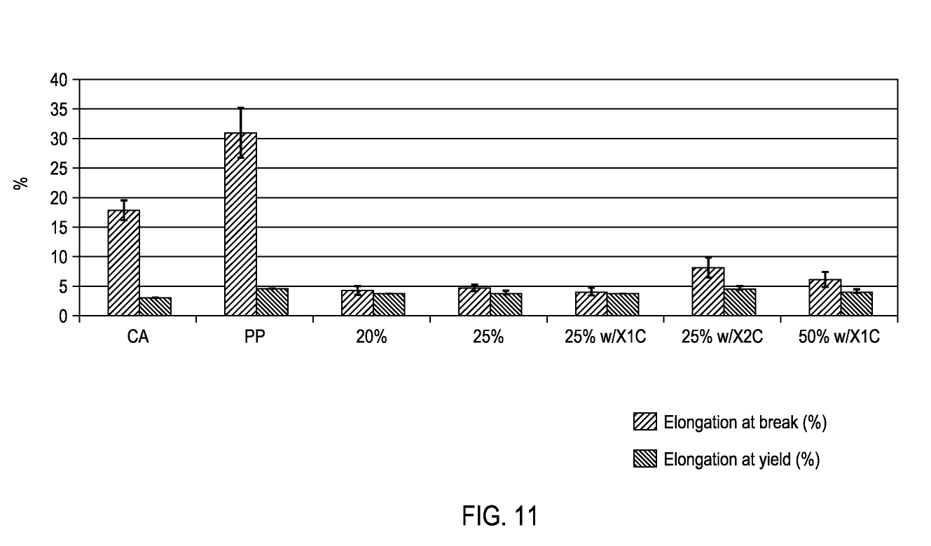

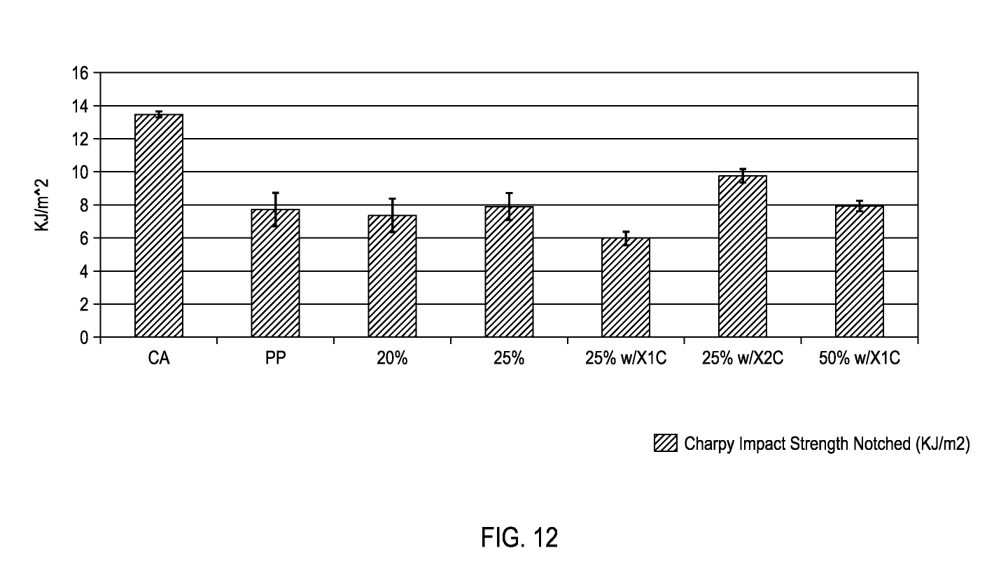

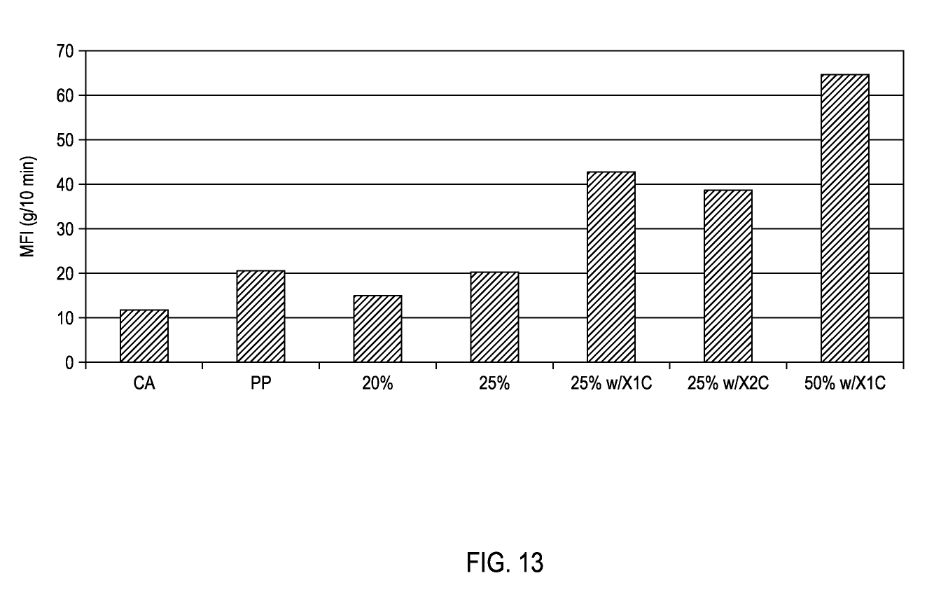

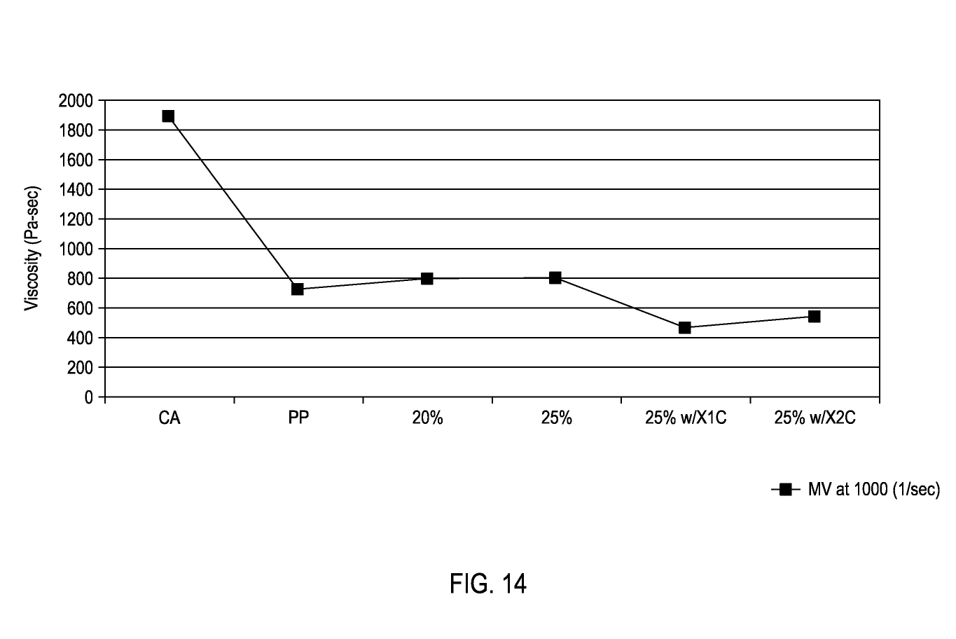

The tensile strength and flexural modulus of the samples were measured by the ISO 527-1:2012 procedure, FIG. 9. The tensile strength at break, the tensile strength at yield, and the flexural strength at 3.5% strain of the samples were measured by the ISO 527-1:2012 procedure, FIG. 10. The elongation to break and the elongation to yield of the samples were measured by the ISO 527-1:2012 procedure, FIG. 11. The Charpy impact strength notched of the samples was measured by the ISO 179-1:2010 procedure, FIG. 12. The MFI of the samples was measured by the ISO 1133 procedure, FIG. 13. The melt viscosity of the samples was measured at 1000 s⁻¹, FIG. 14.

The high MFI and low melt viscosity for Samples 55-57 indicate improved processability over cellulose acetate alone (Sample 51). Further, the mechanical properties are similar to or better than polypropylene alone (Sample 52). Together, this indicates that the blends may be suitable for melt processing and use in articles that require higher DTUL than cellulose acetate alone can achieve. Further, these blends may, because of the cellulose acetate, have improved environmental properties (e.g., degradability and recyclability) over polypropylene alone.

Therefore, this disclosure is well adapted to attain the ends and advantages mentioned as well as those that are inherent therein. The particular embodiments disclosed above are illustrative only, as the embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A cellulose ester plastic comprising:
a plasticized cellulose ester at about 1% to about 99% by weight of the cellulose ester plastic, the plasticized cellulose ester consisting of a cellulose ester at about 60% to about 90% by weight of the plasticized cellulose ester and a plasticizer at about 10% to about 40% by weight of the plasticized cellulose ester, wherein the plasticizer comprises a carbonate ester, a polyol benzoate, or both; and
a thermoplastic polymer at about 1% to about 99% by weight of the cellulose ester plastic; and
wherein the cellulose ester plastic is melt processable.

2. The cellulose ester plastic of claim 1, wherein the plasticizer comprises a carbonate ester, a polyol benzoate, or both.

3. The cellulose ester plastic of claim 2, wherein the plasticizer further comprises at least one other plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

4. The cellulose ester plastic of claim 3, wherein the plasticizer consists of about 15% to about 85% of the carbonate ester, the polyol benzoate, or both and about 15% to about 85% of the other plasticizer.

5. The cellulose ester plastic of claim 3, wherein the plasticizer consists of about 50% to about 75% of the carbonate ester, the polyol benzoate, or both and about 25% to about 50% of the other plasticizer.

6. The cellulose ester plastic of claim 1 further comprising: a compatibilizer at about 0.1% to about 20% by weight of the cellulose ester plastic.

7. A method comprising:
injection molding the cellulose ester plastic of claim 1 at about 190° C. to about 240° C. to form an injection molded article.

8. A plasticized cellulose ester consisting of:
a cellulose ester at about 80% to about 90% by weight of the plasticized cellulose ester; and
a plasticizer at about 10% to about 20% by weight of the plasticized cellulose ester,
wherein the plasticized cellulose ester is melt processable.

9. The plasticized cellulose ester of claim 8, wherein the plasticizer comprises a carbonate ester, a polyol benzoate, or both.

10. The plasticized cellulose ester of claim 9, wherein the plasticizer further comprises at least one other plasticizer selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, tribenzoin, polycaprolactone, glycerin, glycerin esters, diacetin, glycerol acetate benzoate, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, C₁-C₂₀ dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, butylated hydroxytoluene, butylated hydroxyanisol, sorbitol, xylitol, ethylene diamine, piperidine, piperazine, hexamethylene diamine, triazine, triazole, pyrrole, and any combination thereof.

11. The plasticized cellulose ester of claim 10, wherein the plasticizer consists of about 15% to about 85% of the carbonate ester, the polyol benzoate, or both and about 15% to about 85% of the other plasticizer.

12. The plasticized cellulose ester of claim 10, wherein the plasticizer consists of about 50% to about 75% of the carbonate ester, the polyol benzoate, or both and about 25% to about 50% of the other plasticizer.

13. The plasticized cellulose ester of claim 8, wherein the plasticizer comprises at least one carbonate ester selected from the group consisting of: propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, and phenyl tridecyl carbonate.

14. The plasticized cellulose ester of claim 8, wherein the plasticizer comprises at least one polyol benzoate selected from the group consisting of: glyceryl tribenzoate, propylene glycol dibenzoate, diethylene glycol dibenzoate, dipropylene glycol dibenzoate, triethylene glycol dibenzoate, polyethylene glycol dibenzoate, neopentylglycol dibenzoate, trimethylolpropane tribenzoate, trimethylolethane tribenzoate, pentaerythritol tetrabenzoate, and sucrose benzoate.

15. A method comprising:
injection molding the plasticized cellulose ester of claim 8 at about 190° C. to about 240° C. to form an injection molded article.
